(19) United States
(12) Patent Application Publication
(10) Pub. No.: US 2008/0168354 A1
(43) Pub. Date: Jul. 10, 2008

(54) Device command shell system function through a web browser interface

(76) Inventor: Scott Randall Thompson, (US)

Correspondence Address: Scott Thompson, 9115 Koronowski Road, Marcy, NY, 13403, US

(21) Appl. No.: 11/620,706

(22) Filed: Jan. 7, 2007

(51) Int. Cl. G06F 3/00

(52) U.S. Cl. 715/733

(57) ABSTRACT

Numerous hardware and software devices provide a text-based command-line interface known as a command-prompt or command shell. These command-line user interfaces only take in text-based input from the user to perform commands and/or interact with the device in some way. For network-enabled devices, these command-line interfaces can be exercised remotely through software viewed on web pages through a web browser via a system where the web page takes the user input, forwards the input to the device, gathers the response from the hardware or software device, and returns the data to the user on the web page. Additionally, the underlying device command function could be emulated and presented via the web page.

### SUMMARY OF THE INVENTION

It is the object of the invention to provide command-line functionality for a hardware or software device through a web browser interface.

It is another object of the invention to replicate the command-line interface of a hardware or software device through a web browser interface.

The invention will take entered input at the web browser command prompt. The invention will then forward the request using the best available means for the device to the hardware or software device for processing. The invention will then get a response back from the device. This response will be relayed back to the user via the web browser command prompt.

What is claimed is:

1. A command-line interface system presented to a user via a web page for hardware or software device(s) that support a command-line interface that can be linked to a network.

2. A system that, according to claim 1, can take text input from the user, forward the request to the hardware or device for processing, and return the command-line output from the device back to the user via a web page.

3. A system that, according to claims 1 and 2, can emulate a command-line interface system through a web browser for a hardware or software device.
